(19) United States
(12) Patent Application Publication
(10) Pub. No.: US 2007/0070815 A1
(43) Pub. Date: Mar. 29, 2007

(54) Circuit adapted for pressure-sensitive switch and its use in a hydrophone array

(76) Inventors: William H. Hulsman, East Falmouth, MA (US); Glen Ferguson, Monument Beach, MA (US)

Correspondence Address: FRANCIS J. CAUFIELD, 6 APOLLO CIRCLE, LEXINGTION, MA, 02421-7025, US

(21) Appl. No.: 11/503,637

(22) Filed: Aug. 14, 2006

Related U.S. Application Data
(60) Provisional application No. 60/710,530, filed on Aug. 23, 2005.

(51) Int. Cl. G01V 1/20

(52) U.S. Cl. 367/154

(57) ABSTRACT

The present invention is directed to a circuit incorporating a pressure-sensitive switch that operates in a normally-open position and disables an associated survey sensor (e.g. a hydrophone) at predetermined depths. The circuit comprises a non-mechanical switch connected in series with the sensor and also connected to the pressure-sensitive switch so that when the pressure-sensitive switch is closed, the non-mechanical switch becomes non-conductive relative to the associated sensor, thus causing the signal from the associated sensor to be disconnected. The circuit may be connected with an associated sensor in parallel with an array of other sensors so that the circuit does not affect the operation of the other sensors in the array.

### CROSS-REFERENCE TO RELATED APPLICATION

This application claims the benefit of priority from U.S. Provisional Patent Application No. 60/710,530 entitled CIRCUIT ADAPTED FOR PRESSURE-SENSITIVE SWITCH AND ITS USE IN A HYDROPHONE ARRAY and filed on Aug. 23, 2005, the entire contents of which are incorporated herein by reference.

### FIELD OF THE INVENTION

This invention in general relates to pressure-sensitive switches and, in particular, to such switches provided with circuits adapted for use with multi-hydrophone streamer arrays.

### BACKGROUND OF THE INVENTION

Pressure-sensitive switches are used in a variety of applications where it is desired to switch apparatus on or off at predetermined pressures. Switching may be desirable, for example, because the electrical circuitry controlled by the switch may exceed its design limits, might be damaged, or give inaccurate and misleading readings when operated at extreme pressures. Government regulations also require the use of pressure-sensitive switches in certain commercial forms of apparatus that are capable of both commercial and military uses (so-called dual use technology) to prevent the commercial forms from being converted to military applications.

One important application of pressure-sensitive switches is in hydrophone streamer cable arrays used in underwater surveying. In such surveying, a survey ship tows a plurality of submerged cables extending substantially parallel to the ship's direction of travel. The “streamer” is often divided into separate sections, towed in parallel, transmitting collected data through integrated cables to onboard recording and processing devices. Because of export regulations placed on such streamer cable arrays (requiring that they cannot be used below particular depths), pressure-sensitive switches are presently used to deactivate the hydrophones below the predetermined depths.

The pressure-sensitive switches used in hydrophone array applications are generally of either the normally closed or normally open variety, connected electrically with an associated hydrophone in the array. An example of the normally open variety is described in U.S. Pat. No. 6,318,497. An advantage of using a normally open switch is that it is non-conductive relative to the hydrophone array while the sensors are operating and therefore avoids the possibility of introducing undesirable noise on signal channels. On the other hand, transmitting signals through closed mechanical switches can introduce undesirable noise where the switches vibrate during operation, especially under dynamic conditions such as those prevalent during undersea surveying. A typical circuit incorporating normally-open pressure-sensitive switches in hydrophone arrays, as shown in FIG. 1 and generally designated 1, connects the switches 3 in parallel with the hydrophones 2, thus causing a short in the transmission signal and disabling the hydrophone(s) when the switch 3 closes.

An inherent aspect of prior circuit arrangements incorporating normally open-switches is that when the switch closes, the entire array or array section of hydrophones (typically comprising a “group” or “channel” of 7-16 hydrophones) becomes disabled. Where a particular switch closes, shorts, or otherwise fails above the predetermined depth, data will not be collected from the hydrophone's whose associated pressure-switches properly remain open and thus, in some cases, result in the unnecessary loss of data.

It is thus an object of the invention to provide a circuit for use with normally-open mechanical switches which provides superior noise-reduction characteristics and limits the disabling effect of the normally-open switch to only associated hydrophones.

Other objects of the invention will, in part, appear hereinafter and, in part, be obvious when the following detailed description is read in connection with the drawings.

### SUMMARY OF THE INVENTION

This invention provides a circuit adapted for use with a pressure-sensitive switch that disables an underwater survey sensor and includes a non-mechanical switch connected in series with the survey sensor so that, when the pressure-sensitive switch is closed, the non-mechanical switch becomes non-conductive and disables the survey sensor.

In one aspect of the invention, when a normally-open pressure sensitive switch is closed, a voltage across the non-mechanical switch is shorted, which triggers the non-mechanical switch to become non-conductive with respect to the survey sensor. The invention provides, in one aspect, that the non-mechanical switch is a MOSFET and is powered by a voltage source connected in parallel with the pressure-sensitive switch.

In another aspect of the invention, the pressure-sensitive switch is a normally-open switch including a base member having a mounting surface formed of electrically-insulating material having first and second electrodes mounted on the base member; each of the electrodes having an exposed, electrically-conductive contact surface disposed adjacent the mounting surface of the base member. The switch also includes a flexible diaphragm having a peripheral portion fixedly secured in a substantially fluid-tight manner to the mounting surface and a central portion overlying the contact surfaces of the first and second electrodes, wherein at least the central portion of the diaphragm is formed of electrically-conductive material, exposed to the pressure surrounding the switch, and formed with plural corrugations. Thus, when the switch is exposed to atmospheric pressure, the central portion of said diaphragm is spaced from the contact surfaces of the electrodes, but when the switch is exposed to a pressure substantially in excess of atmospheric pressure, the central portion of the diaphragm is forced into contact at a predetermined pressure with both contact surfaces, thereby electrically connecting the first and second electrodes to each other.

### BRIEF DESCRIPTION OF THE DRAWINGS

The structure, operation, and methodology of the invention, together with other objects and advantages thereof, may best be understood by reading the following detailed description in connection with the drawings in which each part has an assigned numeral or label that identifies it wherever it appears in the various drawings and wherein:

FIG. 1, as already described, is a diagram of a prior art circuit incorporating a normally-open pressure-sensitive switch;

FIG. 2 is a general simplified circuit diagram according to an embodiment of the invention in which the presssure sensitive switch is normally opened;

FIG. 3a is a more detailed circuit diagram of the embodiment of FIG. 2 incorporating a MOSFET as the non-mechanical switch in accordance with the invention;

FIG. 3b is a detailed circuit diagram of a circuit of the invention incorporating a MOSFET in conjunction with a normally closed pressure sensitive switch;

FIG. 4 is a cross section of a normally opened pressure-sensitive switch in accordance with an embodiment of the inventive circuit;

FIG. 5A is a top plan view of the base member of the pressure-sensitive switch shown in FIG. 4;

FIG. 5B is an underneath plan view of the base member of the pressure sensitive switch shown in FIG. 4; and,

FIG. 6 is a top plan view of the diaphragm of the pressure-sensitive switch shown in FIG. 4.

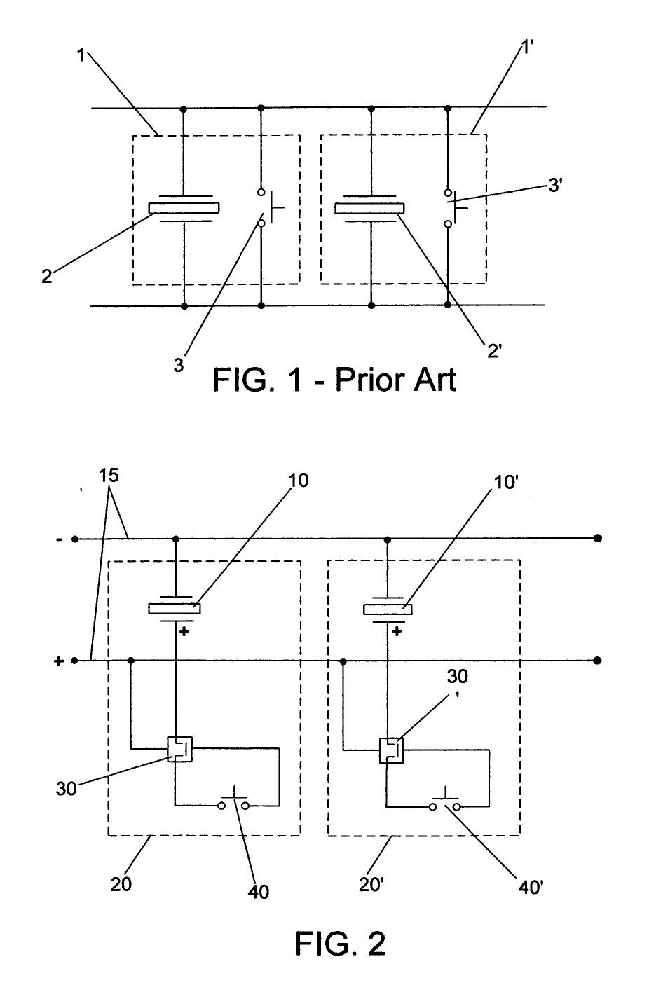

### DETAILED DESCRIPTION

Reference is now made to FIG. 2 which shows a basic diagram in accordance with the inventive circuit where it is repeated a number of times in an array of hydrophones and is generally designated as 20, 20′, etc. Each survey sensor of the array is preferably a hydrophone 10 that is connected in series with a non-mechanical switch 30. The non-mechanical switch 30 is connected with a pressure-sensitive switch 40 such that, when the pressure-sensitive switch 40 is closed, non-mechanical switch 30 responds by disconnecting the output of sensor 10 from sensor array output terminals 15. In the array of sensors, the circuit (20, 20′, . . . ) is repeated for each individual sensor (10, 10′, . . . ) respectively, and each circuit is connected in parallel with the others so that the closure or failure of one pressure-sensitive switch does not disconnect the output of non-associated sensors in the array.

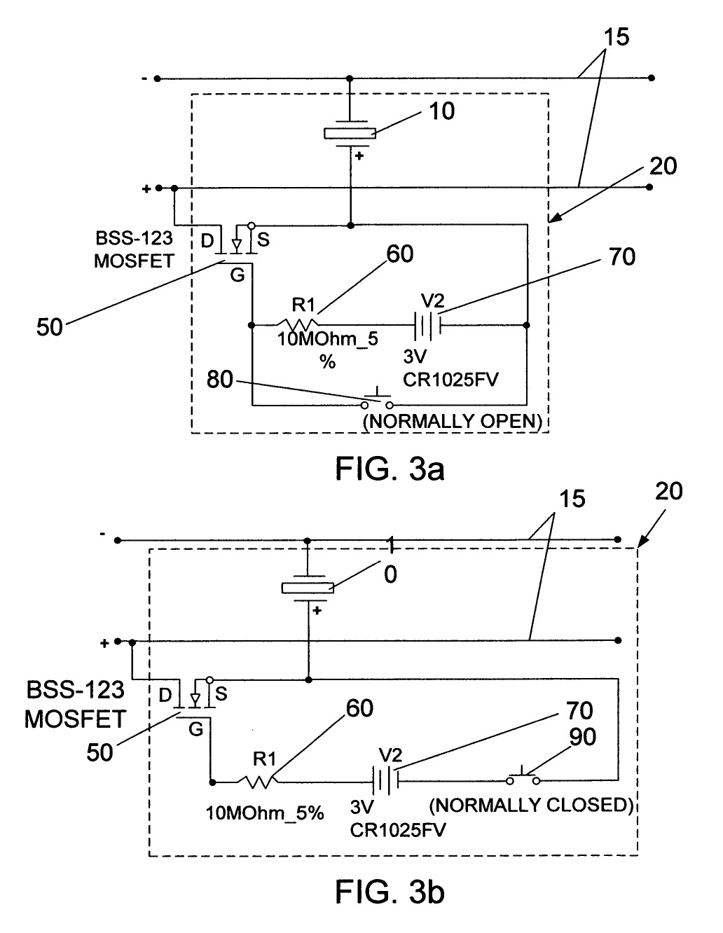

Now referring to FIG. 3a, an embodiment of the inventive circuit uses an FET as the non-mechanical switch 50 shown with source (S), gate (G), and drain (D) terminals. Switch 50 is held on by a voltage source, a battery 70, connected in parallel to a normally opened pressure-sensitive switch 80. Thus, when the pressure-sensitive switch 80 closes, the voltage (G to S) is brought to zero volts, which cuts off the FET, which then becomes non-conductive to the output from sensor 10, disconnecting it from the rest of the array. A resistor 60 prevents rapid discharge of battery 70 when pressure-sensitive switch 80 closes. Placement of the pressure-sensitive switch 80 between the FET and sensor 10 isolates the switch from the other sensors in the group, thus reducing noise generated by the switch in the circuit.

In a preferred embodiment, non-mechanical switch 50 is a model BSS-123 MOSFET, resistor 60 is rated at 10 Mohm with a tolerance of +/−5%, battery 70 provides a long-lasting 3 volt supply (e.g., model CR1025FV), and the pressure-sensitive switch is of a normally-open diaphragm type as described further below in the specification and in more detail in U.S. Pat. No. 6,318,497, the entire contents of which are incorporated herein by reference.

Now referring to FIG. 3b, an embodiment of the inventive circuit 20 incorporates a normally closed pressure-sensitive switch 90, which is connected in series with battery 70 and resistor 60. Thus, when pressure-sensitive switch 90 is closed, non-mechanical switch 50 conducts from sensor 10 but when pressure-sensitive switch opens under pressure, non-mechanical switch 50 is cut off from battery 70 and terminates the signal from sensor 10.

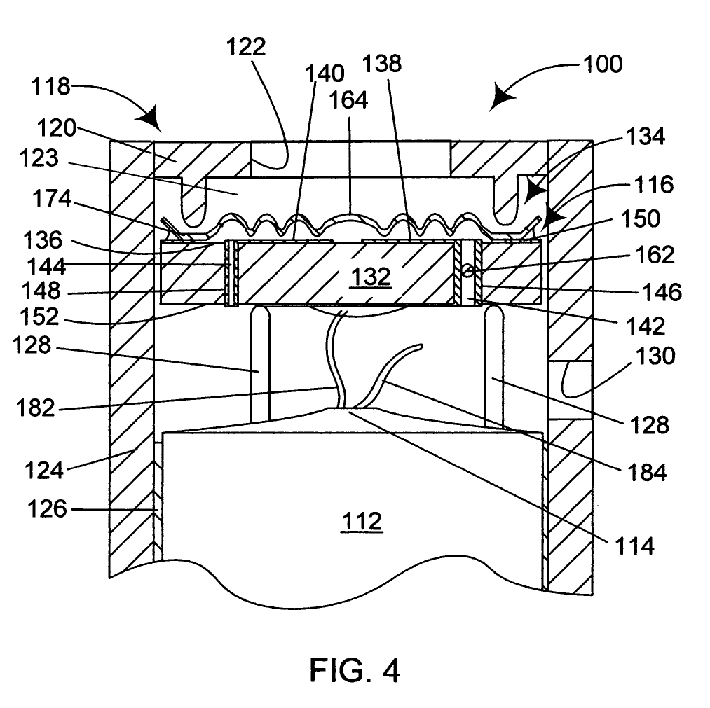

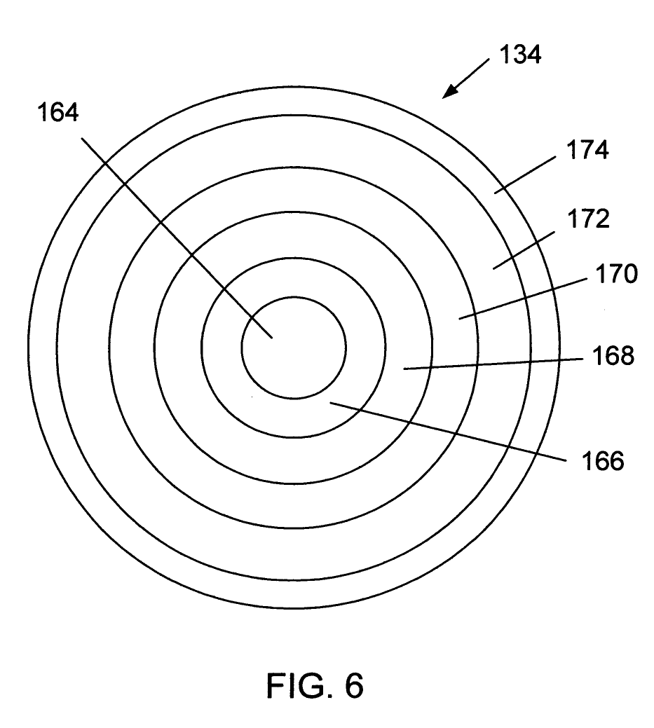

Now referring to FIG. 4, there is shown, in section, a normally opened pressure-sensitive switch 100 for use with the inventive circuit of FIG. 3a. Pressure sensitive switch 100 has two main components, a base member 132 having the form of a flat, circular plate formed of electrically-insulating material (e.g., G-10), and a diaphragm (generally designated 134), which is secured to the upper surface 136 of the base member 132 in a manner described in detail below with reference to FIG. 6. The base member 132 is, in effect, a small, double-sided printed circuit board, and indeed, it is one of the advantages of the preferred embodiment of the switch that the base member 132 can be inexpensively produced in large volumes with excellent yield using conventional, well-understood techniques for the manufacture of printed circuit boards.

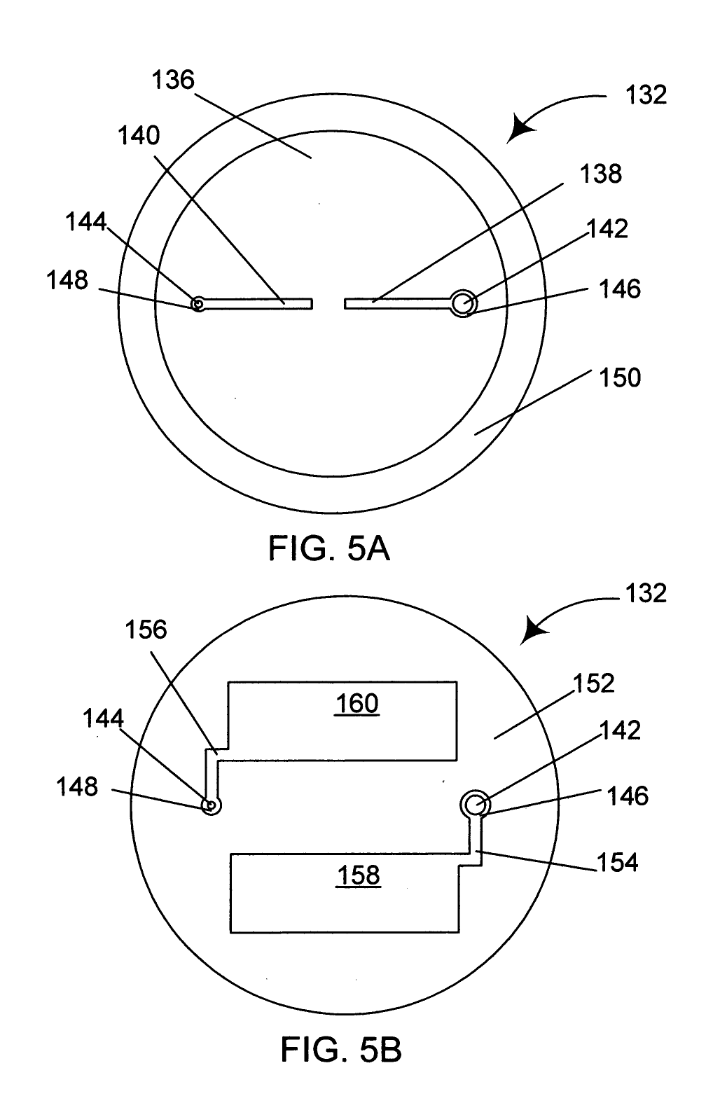

As best seen in FIG. 5A, the upper mounting surface 136 of base member 132 is provided with first and second flat, laminar, elongate rectangular metal electrodes 138 and 140 which extend radially outwardly from adjacent the axis of the circular mounting surface 136, the two electrodes 138 and 140 being separated by a small gap in the center of the mounting surface 136. The radially outward ends of the electrodes 138 and 140 lie adjacent apertures 142 and 144, respectively, the aperture 142 being of larger diameter than the aperture 144. As best seen in FIG. 4, the apertures 142 and 144, which extend completely through the base member 132, bear internal metal coatings, 146 and 148, respectively, and the upper ends of these coatings 146 and 148 contact the electrodes 138 and 140, respectively. The mounting surface 136 also bears around its periphery a conductive metal annulus 150. As shown in FIG. 5B, the ends of the coatings 146 and 148 at the lower (in FIG. 4) surface 152 of the base member 132 contact conductors 154 and 156, respectively, which extend from the coatings 146 and 148 to flat, laminar, rectangular contact pads 158 and 160, respectively. The electrodes 138, 140, the contact pads 158 and 160, the conductors 154 and 156, and the annulus 150 can be formed by printing or similar processes, while the internal metal coatings 146 and 148 can be formed by techniques well known to those skilled in printed circuit board technology. In the areas of the surfaces 136 and 154 of the base member 132 not covered by the electrodes, contact pads conductors, internal coatings or annulus already described, the electrically-insulating material from which the base member 132 is formed is exposed, so these areas of the surfaces 136 and 152 are electrically insulating. The larger aperture 142 is blocked in a gas-tight manner by a sealing member 162 (see FIG. 4).

As shown in FIGS. 4 and 6, the diaphragm 134 has essentially the form of a corrugated metal disk. More specifically, the diaphragm 134 has a central metal boss 164 located on its axis and, in order moving radially outwardly from this boss 164, three corrugations 166, 168 and 170, each of which is centered on the axis of the diaphragm 134, an annular contact portion 172, which lies flat against the annulus 150 (see FIG. 4), and a peripheral flange 174 which extends outwardly and upwardly away from the mounting surface 136. The peripheral flange 174 is secured, in a gas-tight manner by solder to the annulus 150 on the mounting surface 136. The solder is drawn into the joint by capillary action, and extends beneath the contact portion of the diaphragm 134.

The proposed preferred pressure-sensitive switch, including variations and methods of manufacture thereof, are described more fully in U.S. Pat. No. 6,318,497, incorporated herein by reference as previously indicated.

Having described the invention with reference to particular embodiments, other variations will occur to those skilled in the art based on its teachings, and it is intended that all such variants be within the scope of the invention as defined by the claims.

I claim:

1. A circuit for interrupting the signal from an underwater survey sensor when a pressure-sensitive switch is activated, said circuit comprising:
a power supply;
an electronic switch connected in series with a survey sensor_and said power supply so that said switch normally conducts to pass signals from the survey sensor to a signal channel; and
a pressure-sensitive switch connected with said power supply and said electronic switch so that, when said pressure-sensitive switch is activated, said electronic switch becomes non-conductive relative to said survey sensor thereby preventing signals from being passed to the signal channel.

2. The circuit of claim 1 wherein said pressure-sensitive switch is normally open and when closed, said pressure-sensitive switch shorts out the voltage across said electronic switch, thereby causing said electronic switch from conduction output from said sensor.

3. The circuit of claim 1 wherein said pressure-sensitive switch is normally closed and when open, said pressure-sensitive switch disconnects the voltage across said electronic switch, thereby causing said electronic switch from conducting output from said sensor.

4. The circuit of claim 1 wherein said electronic switch is an FET and is powered by said power source that is connected in parallel to said pressure-sensitive switch.

5. The circuit of claim 1 wherein said pressure-sensitive switch comprises:
a base member having a mounting surface formed of electrically-insulating material;
first and second electrodes mounted on said base member, each of said electrodes having an exposed, electrically-conductive contact surface disposed adjacent said mounting surface of said base member; and
a flexible diaphragm having a peripheral portion fixedly secured in a substantially fluid-tight manner to said mounting surface and a central portion overlying said contact surfaces of said first and second electrodes, at least said central portion of said diaphragm being formed of electrically-conductive material, being exposed to the pressure surrounding said switch, and being formed with plural corrugations,
such that when said switch is exposed to atmospheric pressure, said central portion of said diaphragm is spaced from said contact surfaces of said electrodes, but when said switch is exposed to a pressure substantially in excess of atmospheric pressure, said central portion of said diaphragm is forced into contact at a predetermined pressure with both said contact surfaces, thereby electrically connecting said first and second electrodes to each other.

6. An underwater survey apparatus comprising:
a plurality of underwater survey sensors connected in parallel electrically, each of said sensors connected in series with an associated circuit that disables said sensor at predetermined depths without disabling other sensors, each of said associated circuits including a pressure-sensitive switch.

7. The apparatus of claim 6 wherein said survey sensors are hydrophones and wherein each of the associated circuits that disables the associated hydrophone include a FET connected in series with the output of the associated hydrophone such that said FETs only conduct output from the associated hydrophone when the associated normally-open pressure-sensitive switch is open.
